(19) United States
(12) Patent Application Publication
(10) Pub. No.: US 2026/0128999 A1
(43) Pub. Date: May 7, 2026

(54) ANOMALY DETECTION BASED ON CONGESTION NOTIFICATIONS

(71) Applicant: T-MOBILE INNOVATIONS LLC, Overland Park, KS (US)

(72) Inventors: Timur Kochiev, Irvine, CA (US); Relin Thomas, Seattle, WA (US)

(21) Appl. No.: 18/939,113

(22) Filed: Nov. 6, 2024

(51) Int. Cl. H04L 47/26; H04L 41/16; H04L 47/12

(52) U.S. Cl. CPC H04L 47/26; H04L 41/16; H04L 47/12

(57) ABSTRACT

Systems, methods, and software are disclosed herein for anomaly detection in a wireless communication network based on congestion notification in various implementations. In one example, a computing apparatus processes network telemetry data and congestion data using a machine learning model trained to detect anomalous behavior on wireless communication network. In response to detecting the anomalous behavior, the computing apparatus identifies a source of the anomalous behavior on the network and initiates an action with respect to a network function associated with the source of the anomalous behavior to mitigate one or more effects of the anomalous behavior.

### TECHNICAL FIELD

Aspects of the disclosure are related to the field of wireless communication networks, particularly anomaly detection and root cause analysis of anomalies.

### BACKGROUND

In wireless network communications, excessive traffic congestion can lead to excess latency, buffer bloat, and packet loss, where packets are dropped to signal congestion to the sender. Network congestion is particularly detrimental to transmissions associated with time-critical applications such as VoIP (voice over IP), videoconferencing, live streaming, online gaming, and other types of traffic which rely on low latency and low packet loss to provide a high-quality user experience. For example, in cloud gaming and augmented/virtual reality (AR/VR) applications, network congestion can lead to jitter and freezing which degrades the user experience. Conventional efforts to detect congestion within the network infrastructure include detecting excessive packet loss, monitoring network latency, tracking bandwidth utilization, and analyzing patterns of retransmissions.

To address the challenges to speed and reliability of time-critical data transmission, Low Latency, Low Loss, Scalable Throughput (L4S) technology enables traffic management to reduce congestion build-up, thereby reducing the detrimental effects of congestion on transmission. L4S relies on an extension of the Internet Protocol (IP) defining Explicit Congestion Notification (ECN) by which network traffic can be marked in such a way as to signal to ECN-enabled senders to reduce their transmission rates to alleviate a congestion build-up, rather than dropping packets to signal the build-up to a sender. More specifically, when an ECN-aware router detects that traffic congestion is exceeding a traffic congestion threshold, the router marks the IP header of a packet queued at the router to indicate “Congestion Experienced.” This mark, when received at an ECN-aware endpoint, causes the endpoint to echo the congestion indication back to the ECN-aware sender, which in turn causes the sender to reduce its transmission rate. By reducing the transmission rate, congestion is alleviated, resulting in reduced packet loss and improved latency.

### OVERVIEW

Technology is disclosed herein for anomaly detection in a wireless communication network based on congestion notification in various implementations. In one example, a computing apparatus comprises one or more computer readable storage media, one or more processors operatively coupled with the one or more computer readable storage media and program instructions stored on the one or more computer readable storage media that, when executed by the one or more processors, direct the computing apparatus to process network telemetry data and congestion data using a machine learning model trained to detect anomalous behavior on wireless communication network; in response to detecting the anomalous behavior, identify a source of the anomalous behavior on the wireless communication network; and initiate an action with respect to a network function associated with the source of the anomalous behavior to mitigate one or more effects of the anomalous behavior.

In another example, a method of operating a computing apparatus comprises processing network telemetry data and congestion data using a machine learning model trained to detect anomalous behavior on wireless communication network; in response to detecting the anomalous behavior, identifying a source of the anomalous behavior on the wireless communication network; and initiating an action with respect to a network function associated with the source of the anomalous behavior to mitigate one or more effects of the anomalous behavior.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for radio resource partitioning based on congestion notification in an implementation.

FIG. 2 illustrates a process for radio resource allocation based on congestion notification in an implementation.

FIG. 3 illustrates an operational environment for radio resource allocation based on congestion notification in an implementation.

FIG. 4 illustrates workflows for radio resource allocation based on congestion notification in an implementation.

FIG. 5 illustrates an operational architecture of a wireless communication network in an implementation.

FIG. 6 illustrates an operational architecture of a wireless communication network in an implementation.

FIG. 7 illustrates a computing system suitable for implementing the various operational environments, architectures, processes, scenarios, and sequences discussed below with respect to the other Figures.

### DETAILED DESCRIPTION

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

Wireless communication networks, with their dynamic and complex nature, are prone to various issues such as security breaches, node failures, and performance degradation. Detecting and diagnosing anomalies is particularly challenging due to the constantly changing network environment, the vast amount of operational and performance data generated, and the imbalance between data related to anomalous events and data representing normal operation. Issues can emerge across any of the many components that make up the network—ranging from RAN node configurations, air interface protocols, core network functions, and transport layers to cybersecurity elements and server configurations. These components may signal anomalous activity through alarms, but network issues are often only addressed after significant events like security breaches or component failures have already occurred.

The technology disclosed herein facilitates the early detection of an anomaly arising on the network based on aggregating and analyzing network telemetry data including network congestion data to detect patterns of behavior in the data indicating an emergent issue. In various implementations, network congestion data is captured based on L4S technology: in ECN-enabled data traffic, a network node or function reads congestion data signaling congestion in the traffic. The congestion signaling causes the sender and receiver of the traffic to alter their transmission bitrates to alleviate the congestion and improve traffic flow. However, real-time congestion data may also be used to aid in detecting and diagnosing anomalies on the network. In various implementations, to monitor network health and detect anomalous behavior, a network function of a wireless communication network captures network telemetry data and congestion data to train a machine learning model, such as a sequence model, on data including patterns of normal and anomalous performance and operation of the network. At inference, when anomalous behavior is detected, the model can detect and signal the anomalous behavior for remediation before a critical failure occurs. In some implementations, the machine learning model may be trained to identify the source of anomalous behavior on the network, which may include classifying the anomaly for initiating remediation. For example, where the anomaly indicates overutilization of a network resource, load balancing may be directly initiated when the anomaly and its classification are determined.

Technical effects of the technology disclosed herein include rapid detection of anomalies including operational or performance issues as they arise on a network. Early detection of issues enables more rapid response and resolution of the issues to maintain the overall health of the network. Rapid detection and resolution of issues provides myriad technical advantages including improved network reliability by proactively identifying issues and reducing downtime; enhanced security by early detection of cyber threats to prevent data breaches; optimized performance and capacity management including detecting and responding to anomalous traffic patterns; cost savings by interceding to prevent a major failure; early warning for predictive maintenance to prevent equipment failure; improved user experience by minimizing service interruptions; network insights and trend analysis to monitor network health and facilitate root cause analysis of anomalies; and improved compliance with service level agreements (SLAs), standards, and regulations.

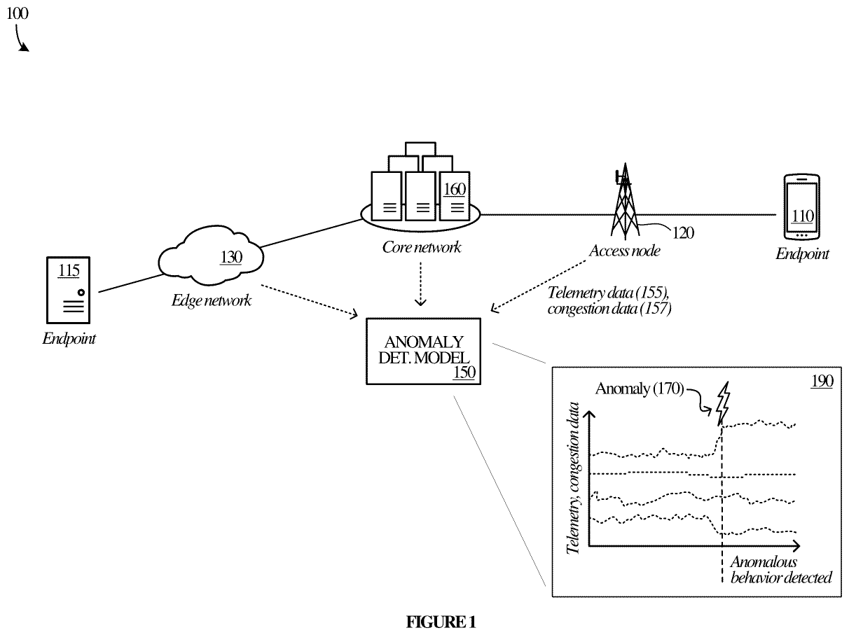

Turning now to the Figures, FIG. 1 illustrates wireless communication network 100 for anomaly detection based on congestion notification in a wireless communication network in an implementation. Wireless communication network 100 includes core network 160 in communication with endpoints 110 and 115 via access node 120 or edge network 130. Wireless communication network 100 also includes anomaly detection model 150 for detecting anomalies as they arise on the network.

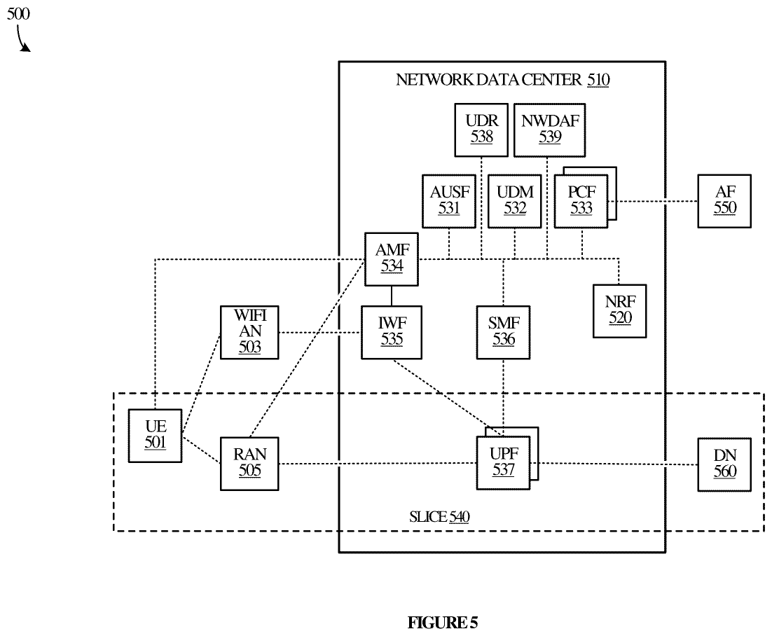

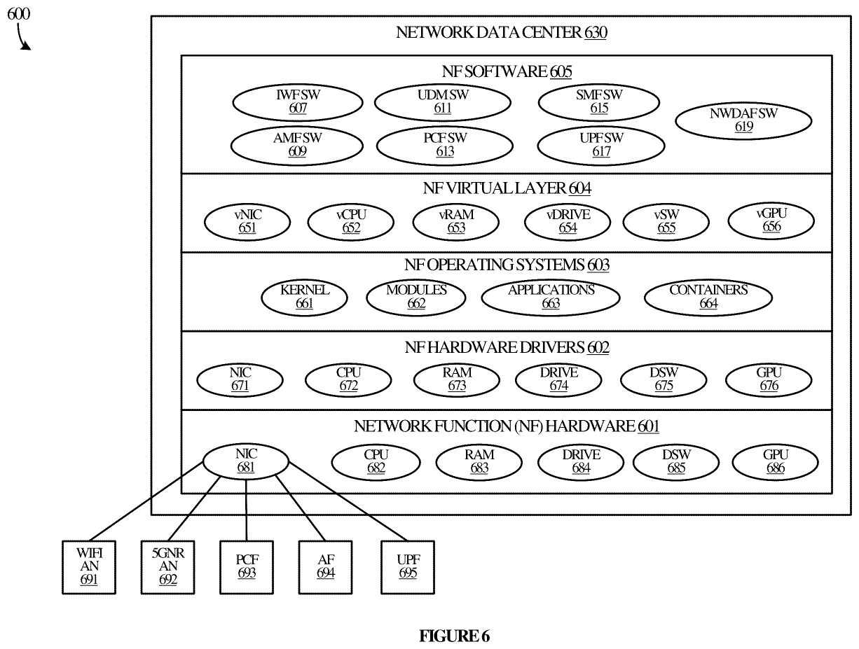

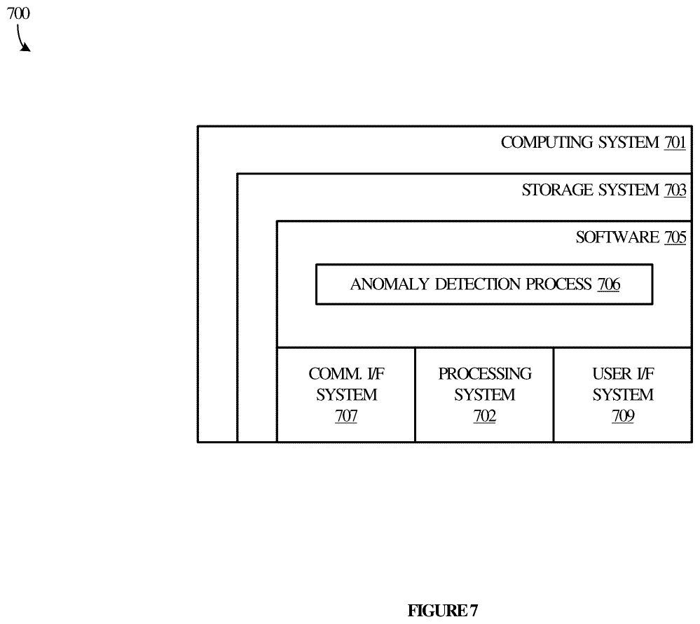

Core network 160 is representative of a core network of a wireless communication system capable of using a Fifth Generation New Radio (5G-NR), 4G LTE, 6G, or other protocol to communicate with L4S-enabled or ECN-enabled devices such as endpoints 110 and 115. In an implementation, core network 160 is representative of a service-based architecture (SBA) which includes network functions (not shown) which constitute the control plane and user plane of a wireless communication network core, of which network data center 510 of FIG. 5 and network data center 630 of FIG. 6 are representative are representative. The network functions of core network 160 are implemented on one or more suitable computing devices, of which computing device 701 of FIG. 7 is representative. Examples of suitable computing devices include server computers, blade servers, and the like. The network elements of core network 160 may be implemented in the context of one or more data centers in a co-located or distributed manner, or in some other arrangement.

Access node 120 is representative of equipment, such as cells or base stations or gNodeBs of Fifth Generation (5G) RANs, access nodes of long-term evolution (LTE) RANs, eNodeBs, macrocells, NB-IoT access nodes, LP-WAN base stations, wireless relays, Wifi access nodes, and/or other wireless or wireline network transceivers. Access node 120 hosts access networks using radio frequencies to provide wireless network connectivity to devices. To communicate with core network 160, access node 120 includes receiving unit (RU) circuitry which communicates along fronthaul data paths to distributed unit (DU) circuitry which in turn communicates with central unit (CU) circuitry along midhaul data paths. Although depicted as a tower, access node 120 may include other physical configurations, including rooftop installations, small-cell sites, distributed antenna systems, vehicle-mounted systems, airborne access nodes, and so on.

Edge network 130 is representative of one or more nodes of a distributed or decentralized computing framework of a wireless communication network such as wireless communication network 100. Edge network 130 provides functionality for data processing and storage closer to devices or systems, such as access node 120, at the edge of the network. Edge network 130 includes equipment such as servers, gateways, storage devices, connectivity infrastructure, and security components (e.g., firewalls, encryption modules, authentication systems) by which to communicate with edge devices such as access node 120.

Endpoint 110 is representative of an L4S-enabled or ECN-enabled device, such as a smartphone or other mobile device, laptop or desktop computer, Internet of Things (IoT) device, wearable device, router, smart vehicle, robot, sensor, controller, augmented or virtual reality device, and the like, of which computing system 701 in FIG. 7 is representative. Endpoint 110 includes processing circuitry for wireless communication with access node 120 or edge network 130 of wireless communication network 100 using protocols such as Fifth Generation New Radio (5G-NR), 5G Advanced, 4G/LTE, 6G, Institute of Electrical and Electronic Engineers (IEEE) 802.11 (Wifi), Low-Power Wide Area Network (LP-WAN), Near-Field Communications (NFC), Code Division Multiple Access (CDMA), Frequency Division Multiple Access (FDMA), and Time Division Multiple Access (TDMA). Endpoint 110 exchanges wireless communication signals with access nodes such as access node 120 of wireless communication network 100 over radio frequency bands. Endpoint 110 also includes functionality by which to signal or respond to network congestion conditions embodied in ECN bits, transmitting ECN data to various functionalities of core network 160 including anomaly detection model 150.

Endpoint 115 is representative of an L4S-enabled or ECN-enabled device or system, such as an application server, database server, content delivery network, authentication and identity server, or a server for other kinds of cloud services of which computing system 701 in FIG. 7 is representative. For communication with edge network 130 or an access node such as access node 120, endpoint 115 includes processing circuitry for wired communication using Ethernet, fiber optic, or other types of connectivity or for wireless communication using protocols such as Fifth Generation New Radio (5G-NR), 5G Advanced, 4G/LTE, 6G, Institute of Electrical and Electronic Engineers (IEEE) 802.11 (Wifi), Low-Power Wide Area Network (LP-WAN), Near-Field Communications (NFC), Code Division Multiple Access (CDMA), Frequency Division Multiple Access (FDMA), and Time Division Multiple Access (TDMA). Endpoint 115 exchanges wireless communication signals with edge network 130 or access node 120 of wireless communication network 100 over radio frequency bands. Endpoint 115 may also include functionality by which to signal or respond to network congestion conditions embodied in ECN bits, transmitting ECN data to various functionalities of core network 160 including anomaly detection model 150.

Anomaly detection model 150 is representative of a functionality implemented in hardware or software for detecting anomalies in a wireless communication network based on network telemetry data including congestion data. Anomaly detection model 150 may be an artificial intelligence (AI), machine learning, or deep learning model which is executed by a network functionality of core network 160, edge network 130, or access node 120. For example, anomaly detection model 150 may be executed by an NWDAF of core network 160. In some implementations, anomaly detection model 150 identifies a source or classification of the anomaly based on a pattern of anomalous behavior detected in the input data. The output generated by anomaly detection model 150 can include information which indicates the contextual information of the anomalous behavior (e.g., where, when the anomaly is occurring), and may include a predicted source of the anomaly or a classification of the anomaly.

In various implementations, anomaly detection model 150 is a sequence model which receives input data based on telemetry data 155 and congestion data 157, processes the input data, and returns information relating to anomalous behavior detected in accordance with its training. For example, anomaly detection model 150 may include a recurrent neural network (RNN), such as a Long Short-Term Memory (LSTM) model or Gated Recurrent Unit (GRU) model which is trained in a process of supervised learning on labeled historical telemetry and congestion data comprising normal and anomalous behavior. In some scenarios, anomaly detection model 150 may include a deep learning model such as a convolutional neural network (CNN) model which learns complex patterns in time-dependent multichannel data for anomaly detection. The CNN model may be trained in a process of supervised learning on labeled training data comprising historical telemetry and congestion data exhibiting normal and anomalous behavior. In some scenarios, anomaly detection model 150 is an autoencoder which is trained in a process of unsupervised learning on historical telemetry and congestion data which exhibits normal behavior patterns. In still other scenarios, anomaly detection model 150 may be a decision tree, support vector machine or other type of artificial neural network which is trained for anomaly detection based on historical telemetry and congestion data.

Although one model is depicted in FIG. 1, it may be appreciated that multiple ones of anomaly detection model 150 may be deployed throughout wireless communication network 100 with each model trained to detect anomalous behavior in the telemetry data and congestion data for discrete sections of wireless communication network 100. For example, one of anomaly detection model 150 may be deployed to edge network 130, core network 160, and access node 120, with each model receiving telemetry and congestion data originating from elements of those networks/nodes.

Telemetry data 155 is representative of performance and/or operational data of wireless communication network 100 such as data, logs, metrics, and status information including performance metrics, event logs, signaling information, resource utilization, and user activity across different layers of the network infrastructure. Telemetry data 155 may include multiple channels or streams of time-series data originating from various network functions of core network 160, edge network 130, and access node 120, such as data relating to traffic patterns and performance metrics, errors, failures, and anomaly detection events, latency, throughput, and jitter information, network slice performance, user mobility and handover data, and the like. For example, telemetry data 155 may include signal quality metrics such as Reference Signal Received Power (RSRP), Signal to Noise Ratio (SNR), and Channel Quality Indicator (CQI) data as well as Quality of Service (QoS) metrics such as bitrate, throughput, latency, jitter, and so on captured at access node 120.

Congestion data 157 is representative of network telemetry data indicative of congestion in data traffic carried by wireless communication network 100, including congestion in data traffic of various network slices carried by wireless communication network 100. In some implementations, congestion data 157 includes ECN data based on reading ECN bits in packet data headers, where the ECN bits may include an ECN congestion notification. For example, congestion data 157 may include values indicative of the quantity of congestion-signaling bits read in data traffic of wireless communication network 100. In some scenarios, congestion data 157 may be received by anomaly detection model 150 as a stream of time-series data based on the congestion-signaling bits detected in the data traffic, such as a quantity of ECN congestion signaling bits, which is continually generated at a node of wireless communication network 160. Indeed, congestion data 157 may be considered a type of network telemetry data; for ease of discussion, congestion data 157 will be discussed in parallel with other kinds of telemetry data which are collectively referred to as telemetry data 155.

Inset view 190 depicts a representation of telemetry data 155 and congestion data 157 of wireless communication network 100 captured over a period of time during which anomaly 170 occurs on the network. As anomaly detection model 150 receives telemetry data 155 and congestion data 157, the model determines in accordance with its training that anomalous behavior has occurred or is occurring and returns an indication of the anomalous behavior. In various implementations, anomaly detection model 150 identifies or classifies a source of anomaly 170 based on the anomalous behavior.

Anomaly 170 illustrated in inset view 190 is representative of an issue, problem, complication, or other suboptimal or anomalous behavior arising in one or more elements of wireless communication network 100. Anomaly 170 can include, for example, a traffic anomaly including unusual patterns in the volume or type of data being transmitted which may indicate a cyberattack, malware, or configuration errors; a signal anomaly including fluctuations in signal strength or quality which may be caused by interference, faulty equipment, or environmental factors; a usage anomaly including unusual behavior in how devices connect or interact with the network, including an increase in the number of failed connections or excessive authentication attempts; a transmission anomaly such as a sudden spike in delay of packet transmission due to network congestion or faulty routing; or some other type of anomaly.

In a brief operational scenario of wireless communication network 100, anomaly detection model 150 receives network telemetry data 155 and congestion data 157 to monitor the health of the wireless communication network 100 in operation. Anomaly detection model 150 may be executed by a network function, such as an NWDAF, which captures telemetry data 155 and congestion data 157 to continuously monitor the network. To monitor the health of the network, anomaly detection model 150 receives and processes time series data which is configured based on slicing telemetry data 155 and congestion data 157 (corresponding in time) into increments of time. For example, the network function hosting anomaly detection model 150 may configure input vectors of data values for submission to the model based on segmenting telemetry data 155 and congestion data 157 into fixed-size overlapping or non-overlapping input sequences, e.g., 100-millisecond increments of time-series data which overlap by 50-milliseconds. Anomaly detection model 150 processes the input vectors and generates an output which indicates whether anomalous behavior is detected in the input data.

Continuing with the brief operational scenario, anomaly 170 arises on wireless communication network 100 which causes anomalous behavior in one or more elements of the network. Anomaly detection model 150 detects the anomalous behavior in telemetry data 155 and congestion data 157 as it is received and processed by the model. Anomaly detection model 150 returns output which flags the time-series data exhibiting anomalous behavior. Anomaly detection model 150 may also identify in its output the component or source which is implicated by the anomalous behavior. The output may also include a classification of the anomaly (e.g., type, severity) and/or a source of the anomaly (e.g., network function causing the anomaly). Based on the output returned by anomaly detection model 150, the source of the anomaly is identified and mitigative action is initiated for the component or source. For example, anomaly detection model 150 may determine that telemetry data from an Access and Mobility Management Function (AMF) of access node 120 is exhibiting an unusually high number of connection failures and that there is also a high-level of congestion in data traffic at access node 120. Based on the output generated by the model, the network function executing anomaly detection model 150 may transmit a signal to one or more control plane functions of wireless communication network 100 or of access node 120 to rebalance the traffic load across other available AMFs. Anomaly detection model 150 may also return a classification of the anomaly as, for example, a traffic anomaly or resource utilization anomaly as opposed to an equipment failure anomaly to ensure that the proper corrective action is taken.

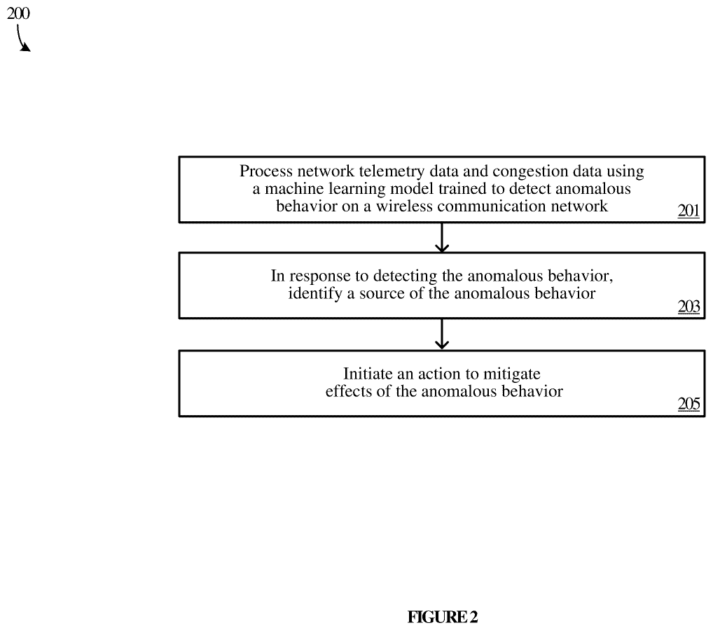

FIG. 2 illustrates a method for anomaly detection based on congestion notification in an implementation, herein referred to as process 200. Process 200 may be implemented in program instructions in the context of any of the software applications, modules, components, or other such elements of one or more computing devices. The program instructions direct the computing device(s) to operate as follows, referred to in the singular for the sake of clarity.

In process 200, a computing device processes network telemetry data and congestion data using a machine learning model trained to detect anomalous behavior on a wireless communication network (step 201). In an implementation, a computing device, such as a network function of the wireless communication network, hosts a machine learning model trained for anomaly detection receives and processes time-series data including network telemetry data and congestion data for anomaly detection. The network function hosting the model may be an NWDAF or other network function which receives telemetry data and performs data analytics or monitoring activity. The machine learning model may be, for example, a recurrent neural network model, a convolutional neural network model, an autoencoder model, or a hybrid model, such as an LSTM autoencoder model.

In an implementation, the telemetry and congestion data are received as time-series data from various components of the network. The computing device configures the time-series data as feature or input vectors for the machine learning model by segmenting the data into sections sized according to the input layer of the machine learning model. The computing device may also aggregate, scale, or normalize the time-series data when populating the input vector.

In some implementations, to process multiple streams of input data based on the telemetry and congestion data, the computing device may execute a multi-channel convolutional neural network with channels corresponding to individual streams of time-dependent telemetry and congestion data. Feature or activation maps produced at various layers of the model may indicate which streams exhibited anomalous behavior. For example, the anomalous behavior may cause certain behaviors in the data that can be detected by certain layers of the model, e.g., spikes, irregular drops, etc. When an anomalous behavior is detected by a layer of the model, this may yield a strong activation output from the layer. By identifying the streams associated with the anomalous behavior, the source of the anomaly giving rise to the behavior may be identified.

In some implementations, the machine learning model is a recurrent neural network, such as an LSTM or GRU autoencoder model, which receives an input vector of telemetry data values and congestion data values and generates output indicating whether the input data exhibits anomalous behavior. The machine learning model may be trained on a labeled dataset of historical telemetry and congestion data in a process of supervised learning, in which the weights and biases of the model are continually adjusted during training to improve the accuracy of the model against ground truth values. Based on its training, the model learns to map sequences of telemetry and congestion data to a binary label or classification (e.g., “normal” versus “anomaly”). For example, for an autoencoder-type model, the input vector data may be encoded to a lower dimensional or latent space representation which essentially summarizes patterns observed in the data. From the encoder process of the model, the lower dimensional representation passes to the decoder process which reconstructs the input data based on the lower dimensional representation. The reconstructed data is a prediction of normal behavior based on the model's training. The input data is compared to the reconstructed data to determine the reconstruction error at each time step, i.e., the difference between the input data and the reconstructed data at each time step. For example, the reconstruction error may be a mean square error (MSE) or absolute error computed for the corresponding input data values and reconstructed data values. If the reconstruction error is low, the output indicates normal behavior, but if the reconstruction error is high, meaning the reconstructed data is significantly different from the input data, the output indicates anomalous behavior. To process multiple streams of time-dependent telemetry and congestion data, the anomaly detection model may be structured to receive the data as an array of data values from the multiple channels which are synchronized in time.

In various implementations, the network telemetry data processed by the computing device by means of the anomaly detection model includes signal quality metrics and QoS metrics generated by various elements of the wireless communication network. The signal quality metrics may include, for example, RSRP, SNR, and CQI values, while the QoS metrics may include values for bitrate, throughput, latency, jitter, packet loss rate, and other transmission data. The network telemetry data may include other metrics as well. For example, the computing device may receive metrics relating to data traffic volume, resource utilization, network security, connectivity, and so on.

In various implementations, the congestion data received and processed by the computing device includes data relating to ECN congestion notifications. In an implementation, the computing device reads packet headers of data packets transiting the wireless communication network to extract ECN bit values embedded in the headers. The ECN bit values may be set in the IP header of a data packet by an ECN-aware router on the communication path of the data packet. ECN-enabled devices at either end of the communication path can read ECN bit values and respond accordingly. For example, if an ECN-aware router marks a packet header to indicate that there is a build-up of network congestion, the ECN-enabled device at the receiving end may respond by downgrading its transmission bitrate and echoing the congestion indication to the sending device (via the ECN-Echo (ECE) flag) in the TCP header of an acknowledgement packet so it can also downgrade its transmission bitrate. By downgrading the bitrate, the congestion build-up may be slowed or even mitigated for network data traffic. To mark the packet, the ECN-aware router sets the rightmost bits of the Traffic Class of the IP header to a value which indicates whether the packet is ECN-enabled and whether congestion has been experienced. For example, ECN bit values of “01” or “10” indicates that the packet is ECN-enabled; “11” indicates that the packet is ECN-enabled and that the router has experienced network congestion. Bit values of “00” indicate the packet is not ECN-enabled.

In response to detecting anomalous behavior, the computing device identifies a source of the anomalous behavior on the wireless communication network (step 203). In an implementation, the computing device receives output generated by the anomaly detection which indicates whether the input data exhibits anomalous behavior. Based on the output, the computing device identifies the source of the anomalous behavior as the network hardware component or network function emitting the anomalous data.

In some implementations, the anomaly detection model receiving multiple streams of telemetry data may return an indication of anomalous behavior in a plurality of streams. The computing device identifies, based on the output of the model, that the source of the anomalous behavior comprises two or more nodes or functions which are transmitting the aberrant data. Together with anomalous behavior detected in congestion data, such as a heightened level of congestion, the computing device may also predict a type or classification, such as severity, of malfunction. For example, if the model returns output indicating that QoS metrics (e.g., packet loss) of higher-priority, congested traffic are suffering, the computing device may classify the anomaly as critical.

When an anomaly arises on a network, symptoms of the anomaly may arise in multiple streams of telemetry data as the effects of the anomaly propagate through the network. In such scenarios, both the source and timing of the anomalous behavior may give rise to a complex pattern across the multiple streams by which the anomaly detection model can identify a source or root cause of the anomaly. By training the anomaly detection model on labeled data which includes anomalous behavior labeled with the identified source of the anomaly, the model can return an identification of the source of the anomaly. For example, in an RNN-type model, by computing the reconstruction error for each channel separately, the channel exhibiting the largest error may be indicated in the output to be the likeliest source of the anomaly. Similarly, for a CNN-type model, higher activations in activation maps produced by the model may be indicated in the output to be the likeliest source of the anomaly.

The computing device initiates an action with respect to a network function associated with the source of the anomalous behavior to mitigate one or more effects of the anomalous behavior (step 205). In an implementation, with anomalous behavior identified and a source of the anomaly identified, the computing device may initiate an action to resolve or mitigate the anomaly. For example, if the anomaly stems from network latency spikes in a wireless communication system, immediate actions might include rerouting traffic to less congested paths or dynamically adjusting bandwidth allocation to reduce bottlenecks. If the anomaly is related to hardware failure, such as packet loss from a failing router, initiating a hardware reset or switching to backup hardware components could mitigate the issue. For anomalies caused by security threats, such as a sudden surge in traffic indicative of a denial-of-service (DoS) attack, automated firewalls can be activated to throttle suspicious traffic or isolate compromised sections of the network. In cases where the anomaly is due to software performance degradation, restarting services or deploying hotfixes to address software bugs could restore normal operations. Monitoring systems may also adjust alert thresholds or implement more frequent checks to prevent future occurrences of similar anomalies.

Referring again to FIG. 1, a brief example of process 200 as employed by elements of wireless communication network 100 follows. In operation, anomaly detection model 150 is executed by a network function or node of wireless network, such as an NWDAF of core network 160, or some other network function of access node 120 or edge network 130. Anomaly detection model 150 receives channels of incoming data, i.e., telemetry data 155 and congestion data 157, from various sources of wireless network 100, such as network functions, routers, or other devices of wireless network 100. To prepare the data for processing, the network function or node hosting the anomaly detection model 150 synchronizes the incoming data and partitions the data to populate feature vectors sized for a specified interval of time for submission to the model. Anomaly detection model 150 then processes the feature vectors to detect anomalous behavior which may indicate an anomaly on the network. In various implementations, anomaly detection model 150 is a machine learning model trained to detect anomalous behavior in multi-channel time-dependent data.

Continuing with the brief example of process 200, the model detects anomalous behavior due to anomaly 170 in one or more data channels of telemetry data 155 and congestion data 157. Anomaly detection model 150 generates an output which indicates the channels exhibiting anomalous behavior. Based on the output from anomaly detection model 150, a source of anomaly 170 is identified, such as the network function or component producing the anomalous data or the most anomalous data. In some cases, particularly where anomalous data occurs more or less simultaneously on multiple channels of data, anomaly detection model 150 may be trained to identify the source of anomaly 170 based on historical telemetry and congestion data which includes data indicating the source or root cause of historical anomalies.

With anomalous behavior detected and the source of anomaly 170 identified, the network function hosting anomaly detection model 150 initiates an action to mitigate the effects of the anomalous behavior. For example, the network function may transmit an alert or an alarm for display in a user interface which indicates the source of anomaly 170. In some cases, the network function may transmit a message to the source to trigger an action for mitigating the effects of anomaly 170, such as rerouting data traffic around the source.

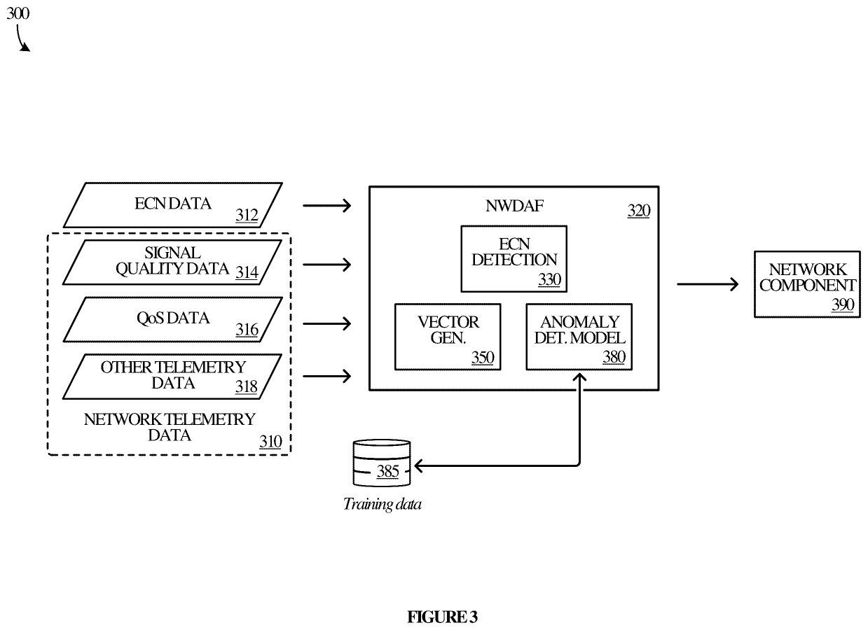

Turning now to FIG. 3, FIG. 3 illustrates operational environment 300 for anomaly detection based on congestion notifications in a wireless communication network in an implementation. Operational environment 300 includes NWDAF 320 which receives network telemetry data 310 and ECN data 312 of the wireless communication network (not shown) and communicates with network function 390. Network telemetry data 310 includes signal quality data 314, QoS data 316, and other telemetry data 318. NWDAF 320 includes ECN detection 330, data processing module 340, vector generation 350, and anomaly detection model 380. Anomaly detection may be trained using training data 385.

NWDAF 320 is representative of a Network Data Analytics Function of a wireless communication network. NWDAF 320 may be implemented in hardware or software in one or more locations of a wireless communication network, such as the network core, an edge network, or an access node. NWDAF 320 receives log data, metrics, and other types of telemetry data from other nodes and network functions of the wireless communication network. NWDAF 320 collects telemetry data from the various network nodes and functions to perform network analytics in support of managing the network including detecting anomalies via a machine learning model.

ECN data 312 is representative of network telemetry data indicative of congestion in data traffic carried by the wireless communication network, including congestion in data traffic of various network slices carried by the network. ECN data 312 includes data, statistics, and metrics derived from reading ECN bits in packet data headers, where the ECN bits may include an ECN congestion notification. For example, ECN data 312 may include values indicative of the quantity of congestion-signaling bits read in data traffic of wireless communication network 100. In some scenarios, ECN data 312 may be received by NWDAF 320 as a stream of time-series data based on the congestion-signaling bits detected in the data traffic, such as a quantity of ECN congestion signaling bits, which is continually generated at a node of the network.

Telemetry data 310 is representative of performance and/or operational data of a wireless communication network such as data, logs, metrics, and status information including performance metrics, event logs, signaling information, resource utilization, and user activity across different layers of the network infrastructure. Telemetry data 310 may also include logs or data of various network functions of the wireless network, such as data relating to traffic patterns and performance metrics, errors, failures, and anomaly detection events, latency, throughput, and jitter information, network slice performance, user mobility and handover data, and the like.

Telemetry data 310 includes signal quality data 314, QoS data 316, and other telemetry data 318. Signal quality data 314 includes Reference Signal Received Power (RSRP), Signal to Noise Ratio (SNR), and Channel Quality Indicator (CQI) data. QoS data 316 includes data relating to bitrate, throughput, latency, jitter, packet loss, and so on captured received from various components of the wireless network. Other telemetry data 318 is representative of other types of time-series telemetry data (e.g., security data, connectivity data) generated by various elements of the wireless communication network.

NWDAF 320 includes ECN detection module 330. ECN detection module 330 is representative of a functionality implemented in hardware or software to capture and process ECN data 312 of transmissions to/from endpoints of the wireless network. ECN detection module 330 generates one or more metrics which quantify the ECN bits detected or the rate of change of the detected ECN bits in transmissions carried by the network. For example, for a given network slice, ECN detection module 330 may generate a metric which indicates the number of ECN bits detected in transmissions carried by the network as a percentage of all transmissions carried for a given period of time. Alternatively, ECN detection module 330 may generate a rate of change in the number of ECN bits that are detected in transmissions carried by the network for a given slice over a given period of time.

NWDAF 320 also includes vector generation module 350. Vector generation module 350 is representative of a functionality implemented in hardware or software for receiving and generating input or feature vectors (i.e., data structures comprising data values organized in an array, the values of which are accessible by an index corresponding to each position in the array) based on ECN data 312 and telemetry data 310 for processing by anomaly detection model 380.

Anomaly detection model 380 of NWDAF 320 is representative of a functionality of NWDAF 320 implemented in hardware or software for detecting anomalous behavior in channels of data received by NWDAF 320. In an implementation, anomaly detection model 380 is an AI or machine learning model trained for anomaly detection, such as a CNN or RNN model. In operation, anomaly detection model receives feature vectors of data values based on incoming streams of telemetry and congestion data and processes the data to generate an indication of normal or anomalous behavior.

Network component 390 is representative of an element or component of the wireless network, such as a control plane or user plane network function such as any of the various network functions illustrated in FIG. 5, router, switch, controllers, load balancers, gateways, servers, access points, and the like.

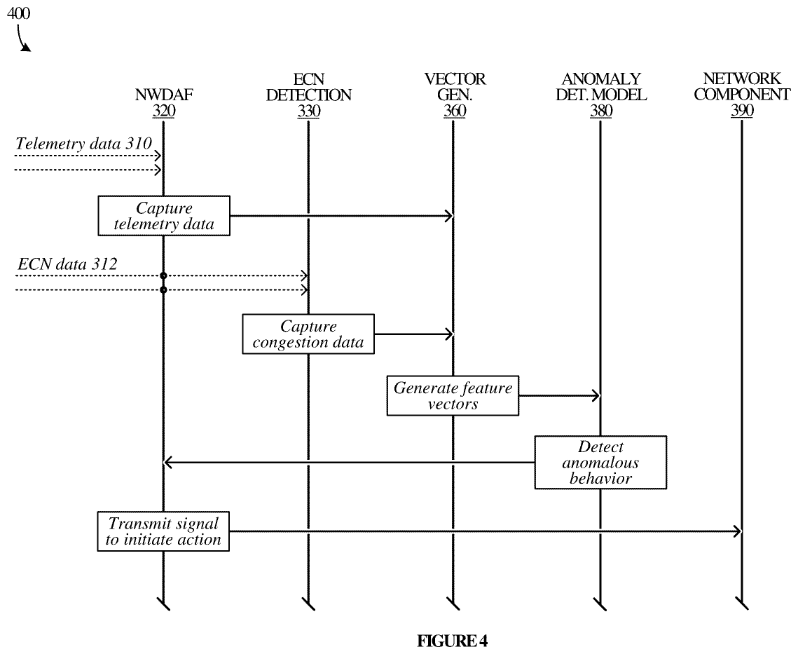

FIG. 4 illustrates workflow 400 for anomaly detection in wireless communication networks in an implementation, referring to elements of operational environment 300. In workflow 400, NWDAF 320 receives continually receives channels telemetry data 310 and ECN data 312 from various elements on the network. For example, telemetry data 310 may be received from network components such as user plane or control plane functions, while ECN data 312 may be received by ECN detection 330 of NWDAF 320 from scheduler devices at access points on the network.

In workflow 400, as incoming telemetry data 310 and ECN data 312 are received, vector generation module 360 synchronizes the incoming streams or channels of data so that the data values are temporally aligned. Vector generation module 360 partitions the incoming streams of data into discrete chunks to populate the feature vectors. As the feature vectors are created, they are fed to anomaly detection model 380 which processes the vectors to detect anomalous behavior. For example, anomaly detection model 380 may return a binary classification of “normal” or “anomalous” for each vector, or the model may return an activation map or other output by which to indicate channels which are exhibiting unusual or anomalous behavior. By correlating the channels exhibiting anomalous behavior to their sources, NWDAF 320 identifies the potential source(s) of the anomaly.

Once anomalous behavior has been detected and a source of the anomaly identified, NWDAF 320 initiates an action to resolve the anomaly depending on the nature of the anomaly. For example, if the anomaly stems from network latency spikes in the wireless communication network, immediate actions might include rerouting traffic to less congested paths or dynamically adjusting bandwidth allocation to reduce bottlenecks. If the anomaly is related to hardware failure, such as packet loss from a failing router, initiating a hardware reset or switching to backup hardware components could mitigate the issue. For anomalies caused by security threats, such as a sudden surge in traffic indicative of a denial-of-service attack, automated firewalls can be activated to throttle suspicious traffic or isolate compromised sections of the network. In cases where the anomaly is due to software performance degradation, restarting services or deploying hotfixes to address software bugs could restore normal operations. Monitoring systems may also adjust alert thresholds or implement more frequent checks to prevent future occurrences of similar anomalies.

To initiate such actions, NWDAF 320 may transmit a message to the source of the anomaly which indicates that an anomaly has been detected. For example, NWDAF 320 receives telemetry data 310 from network component 390 comprising an AMF including packet loss, CPU utilization, and latency data of the AMF. NWDAF 320 also receives ECN data 312 including ECN congestion notifications. NWDAF 320 executes anomaly detection model 380 to process the incoming data to detect anomalous behavior. To execute the model, NWDAF 320 configures a feature vector of time-series data including telemetry data 310 and ECN data 312. Anomaly detection model 380 returns output indicating that anomalous behavior has been detecting on channels corresponding to the telemetry data of the AMF and ECN data 312, specifically, an increase in packet loss, delays in AMF response time, and an increase in network congestion. Based on the output, NWDAF 320 determines that a hardware failure at the AMF is the root cause of the anomaly in progress, and the anomaly is exacerbated by an increase in traffic load at the AMF.

In response to the anomaly, NWDAF 320 transmits a notification to the AMF (network component 390) and an associated network management system to take one or more actions such as rerouting traffic round the AMF, rebalancing the traffic load to reduce the demands on the failing AMF, limiting new connections to the AMF etc. Upon receiving the notification from NWDAF 320, the AMF or network management system performs the actions to mitigate the anomaly.

In another example, NWDAF 320 receives telemetry data 310 from two network component 390 comprising an AMF and a UPF along with ECN data 312. Anomaly detection model 380 receives a feature vector including data values from telemetry data 310 from the AMF and the UPF (including throughput, latency, queue size, and packet loss) and ECN data 312. Anomaly detection model 380 outputs an indication that there is a sharp increase in traffic volume (congestion) and latency, a growing queue size at the UPF, and an increase in packet loss. NWDAF 320 identifies the root cause of the anomaly to be a surge in demand and classifies the anomaly as critical due to the reduced QoS for users based on the increased latency and packet loss. NWDAF 320 transmits notifications to a network management system associated with the AMF and UPF to take one or more actions such as rerouting user traffic to less congested AMFs or UPFs, to increase the allocation of network resources to prioritize more critical traffic to meet QoS requirements, to reduce network resource allocations to less critical traffic, and so on.

FIG. 5 illustrates exemplary wireless communication system 500 that serves wireless User Equipment (UE) 501. Wireless communication system 500 includes UE 501, Wifi Access Node (AN) 503, 5GNR RAN 505, Interworking Function (IWF) 535, Access and Mobility Management Function (AMF) 534, Authentication Server Function (AUSF) 531, Unified Data Management (UDM) 532, Policy Control Functions (PCFs) 533, Session Management Function (SMF) 536, User Plane Function (UPF) 537, Uniform Data Repository (UDR) 538, Network Data Analytics Function (NWDAF) 539, and Application Function (AF) 550. NWDAF 539 receives log data, metrics, and other types of telemetry data from other nodes and network functions of wireless communication system 500. NWDAF 539 collects telemetry data from the various network nodes and functions to perform network analytics in support of managing the network. UDR 538 stores network data including subscriber profiles including identities, subscription details, service preferences, authentication credentials, and billing information. UDR 538 may also store policy data such as network rules, access rules, mobility rules, charging rules, and so on. AF 550 may provide policies applicable to control plane functions, that is, to the application, presentation, and/or session layers of the Open Systems Interconnection (OSI) protocol stack. IWF 535 includes non-3GPP IWFs (N3IWFs) for providing untrusted non-3GPP access to network data center 510, such as access via a non-cellular access network.

Continuing with wireless communication system 500, wireless network slice 540 includes UPF 537 and SMF 536. Wireless network slice 540 is representative of a dynamically allocated slice for hosting service from DN 560 to UE 501 according to the technology disclosed herein, including process 200 or workflow 400. Wireless network slice 540 (such as eMBB, FWA, URLLC, etc.) hosts traffic per the requirements of a QoS for the slice. DN 560 is representative of a data network, Internet access, third-party resource, or other endpoint of an end-to-end communication path from UE 501.

FIG. 6 illustrates exemplary network data center 630, a network core of a wireless communication system, of which wireless network 160 of FIG. 1 is representative. Network data center 630 includes network function (NF) software 605, network function virtual layer 604, network function operating systems 603, network function hardware drivers 602, and network function hardware 601.

Network function software 605 of network data center 630 includes software for executing various network functions: IWF software 607, AMF software 609, UDM software 611, PCF software 613, SMF software 615, UPF software 617, and NWDAF software 619. Other network function software, such as network repository function (NRF) software, are typically present but are omitted for clarity.

Network function virtual layer 604 includes virtualized components of network data center 630, such as virtual NIC 651, virtual CPU 652, virtual RAM 653, virtual drive 654, virtual software 655, and virtual GPU 656. Network operating systems 603 includes components for operating network data center 630, including kernels 661, modules 662, applications 663, and containers 664 for network function software execution. Network function hardware drivers 602 include software for operating network function hardware 601 of network data center 630, including network interface card (NIC) drivers 671 for network interface cards (NICs) 681, CPU drivers 672 for CPUs 682, RAM drivers 673 for RAM 883, flash/disk drive drivers 674 for flash/disk drives 684, data switch (DSW) drivers 675 for data switches 685, and drivers 676 for GPUs 686. Network interface cards 681 of network function hardware 601 include hardware components for communicating with Wifi access node 691, 5GNR access node 692, PCF 693, application server 694, and UPF 695.

FIG. 7 illustrates computing device 701 that is representative of any system or collection of systems in which the various processes, programs, services, and scenarios disclosed herein may be implemented. Examples of computing device 701 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 701 may be implemented as a single apparatus, system, or device or may be implemented in a distributed manner as multiple apparatuses, systems, or devices. Computing device 701 includes, but is not limited to, processing system 702, storage system 703, software 705, communication interface system 707, and user interface system 709 (optional). Processing system 702 is operatively coupled with storage system 703, communication interface system 707, and user interface system 709.

Processing system 702 loads and executes software 705 from storage system 703. Software 705 includes and implements anomaly detection process 706, which is (are) representative of the anomaly detection processes discussed with respect to the preceding Figures, such as processes 200 and workflow 400. When executed by processing system 702, software 705 directs processing system 702 to operate as described herein for at least the various processes, operational scenarios, and sequences discussed in the foregoing implementations. Computing device 701 may optionally include additional devices, features, or functionality not discussed for purposes of brevity.

Referring still to FIG. 7, processing system 702 may comprise a micro-processor and other circuitry that retrieves and executes software 705 from storage system 703. Processing system 702 may be implemented within a single processing device but may also be distributed across multiple processing devices or sub-systems that cooperate in executing program instructions. Examples of processing system 702 include general purpose central processing units, graphical processing units, application specific processors, and logic devices, as well as any other type of processing device, combinations, or variations thereof.

Storage system 703 may comprise any computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device but may also be implemented across multiple storage devices or sub-systems co-located or distributed relative to each other. Storage system 703 may comprise additional elements, such as a controller, capable of communicating with processing system 702 or possibly other systems.

Software 705 (including anomaly detection process 706) may be implemented in program instructions and among other functions may, when executed by processing system 702, direct processing system 702 to operate as described with respect to the various operational scenarios, sequences, and processes illustrated herein. For example, software 705 may include program instructions for implementing an anomaly detection process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtualization software, or other application software. Software 705 may also comprise firmware or some other form of machine-readable processing instructions executable by processing system 702.

In general, software 705 may, when loaded into processing system 702 and executed, transform a suitable apparatus, system, or device (of which computing device 701 is representative) overall from a general-purpose computing system into a special-purpose computing system customized to support anomaly detection in an optimized manner. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary storage, as well as other factors.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

Unless the context clearly requires otherwise, throughout the description and the claims, the words “comprise,” “comprising,” “such as,” and “the like” are to be construed in an inclusive sense, as opposed to an exclusive or exhaustive sense, that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
process network telemetry data and congestion data using a machine learning model trained to detect anomalous behavior on a wireless communication network;
in response to detecting the anomalous behavior, identify a source of the anomalous behavior on the wireless communication network; and
initiate an action with respect to a network function associated with the source of the anomalous behavior to mitigate one or more effects of the anomalous behavior.

2. The computing apparatus of claim 1, wherein the congestion data comprises data based on Explicit Congestion Notification (ECN) congestion notifications.

3. The computing apparatus of claim 2, wherein the congestion data is computed based on a quantity of ECN bits which include an ECN congestion notification with respect to ECN-enabled data traffic on the wireless communication network.

4. The computing apparatus of claim 1, wherein the network telemetry data comprises Quality of Service metrics of the wireless communication network.

5. The computing apparatus of claim 4, wherein the network telemetry data further comprises signal quality metrics of the wireless communication network.

6. The computing apparatus of claim 1, wherein to process the network telemetry data and the congestion data, the program instructions direct the computing apparatus to generate an input vector based on segmenting the network telemetry data and the congestion data and submit the input vector to the machine learning model.

7. The computing apparatus of claim 6, wherein the machine learning model comprises a recurrent neural network trained for anomaly detection using historical network telemetry data and historical congestion data.

8. The computing apparatus of claim 1, wherein the computing apparatus comprises a Network Data Analytics Function of the wireless communication network.

9. A method of operating a computing apparatus, comprising:
processing network telemetry data and congestion data using a machine learning model trained to detect anomalous behavior on a wireless communication network;
in response to detecting the anomalous behavior, identifying a source of the anomalous behavior on the wireless communication network; and
initiating an action with respect to a network function associated with the source of the anomalous behavior to mitigate one or more effects of the anomalous behavior.

10. The method of claim 9, wherein the congestion data comprises data based on Explicit Congestion Notification (ECN) congestion notifications.

11. The method of claim 10, wherein the congestion data is computed based on a quantity of ECN bits which include an ECN congestion notification with respect to ECN-enabled data traffic on the wireless communication network.

12. The method of claim 9, wherein the network telemetry data comprises Quality of Service metrics of the wireless communication network.

13. The method of claim 12, wherein the network telemetry data further comprises signal quality metrics of the wireless communication network.

14. The method of claim 9, wherein processing the network telemetry data and the congestion data comprises generating an input vector based on segmenting the network telemetry data and the congestion data and submitting the input vector to the machine learning model.

15. The method of claim 14, wherein the machine learning model comprises a recurrent neural network trained for anomaly detection using historical network telemetry data and historical congestion data.

16. The method of claim 9, wherein the computing apparatus comprises a Network Data Analytics Function of the wireless communication network.

17. A method of operating a computing apparatus, comprising:
executing a machine learning model to detect anomalous behavior in channels of input data, wherein the input data comprises network telemetry data and congestion data of a wireless communication network;
receiving output from the machine learning model comprising an indication of the anomalous behavior; and
identifying a source of the anomalous behavior based on the output.

18. The method of claim 17, wherein the congestion data comprises data based on Explicit Congestion Notification (ECN) congestion notifications.

19. The method of claim 17, further comprising generating a feature vector based on segmenting the input data synchronized in time and submitting the feature vector to the machine learning model.

20. The method of claim 17, wherein identifying the source of the anomalous behavior based on the output comprises identifying a channel of the channels of input data associated with the indication of anomalous behavior.
